(19) United States
(12) Patent Application Publication
(10) Pub. No.: US 2012/0075041 A1
(43) Pub. Date: Mar. 29, 2012

(54) WAVEGUIDE FILTER

(76) Inventor: Stephen Flynn, Berkshire (GB)

(21) Appl. No.: 13/090,040

(22) Filed: Apr. 19, 2011

Related U.S. Application Data
(63) Continuation of application No. 12/934,517.

(30) Foreign Application Priority Data
Mar. 25, 2008 (GB) GB 0805310.0

(51) Int. Cl. H01P 1/20

(52) U.S. Cl. 333/211; 333/26; 333/230

(57) ABSTRACT

A filter for use with a waveguide which is part of a low-noise block (LNB) for use with VSAT, satellite communications systems is described. The filter is cast into the waveguide wall at the same time as the waveguide is manufactured providing a waveguide filter with a consistent filtering performance.

### CROSS REFERENCE TO RELATED APPLICATIONS

This application is a continuation of application Ser. No. 12/934,517 filed Sep. 24, 2010, which is the 371 filing of International Patent Application PCT/GB2009/000780 filed Mar. 24, 2009.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### REFERENCE TO A SEQUENCE LISTING

Not Applicable

### BACKGROUND

The present invention relates particularly, but not exclusively, to a filter for use with a waveguide which is used in a low-noise block (LNB) for use with satellite communication systems.

In satellite communication systems, LNBs are in widespread use. An LNB typically consists of a waveguide with a waveguide horn directed to receive polarized electromagnetic radiation signals. The waveguide is typically cast from metal and contains at least one probe for collecting incident electromagnetic radiation, which can be linearly or circularly polarized. The probe passes through the waveguide wall and is typically connected to a circuit board where the electrical signals are processed before being passed to a receiver. A waveguide with a probe detection system is disclosed in published International Application WO92/22938 in the name Cambridge Computer Limited.

In VSAT systems there is a requirement to transmit and to receive frequencies in the same waveguide and there is a transmit band present that can interfere with the receive band which could cause reception problems. The electronics of a VSAT system as shown in FIG. 1 will usually comprise a transmitter 1, an LNB 2, a transmit reject filter 3, an orthogonal transducer 4 or diplexer and a feed horn 5. Even with the transmit reject filter, the LNB still needs to be immune or resistant to the residual transmit signal. Rejection of the interfering part of the transmit band is desired and this has been attempted using a waveguide filter created by inserting multiple screws in the waveguide or a pressed metal insert. These attempts to provide a filter require extra component parts which add extra LNG/waveguide manufacturing and testing steps leading to increased cost.

### SUMMARY OF THE INVENTION

The present invention now obviates or mitigates at least one or more of the aforementioned disadvantages of existing waveguide filters.

This is achieved by casting a filter into the waveguide wall at the same time as the waveguide is manufactured providing a waveguide filter with a consistent filtering performance and minimizing manufacturing time and costs.

In accordance with a first aspect of the present invention there is provided a waveguide for use with a VSAT LNB comprising:

a waveguide housing having a waveguide wall for receiving electromagnetic radiation, the waveguide housing having a probe aperture receiving at least one probe for coupling the electromagnetic signal in the waveguide to an electrical signal in a circuit board, filter means cast into said waveguide wall for rejecting selected frequencies in a transmit band.

Preferably, the filter means is cast in said waveguide wall adjacent to said probe aperture.

Preferably also, the filter means is dimensioned and proportioned to provide cancellation of a selected range of frequencies.

Preferably, the filter means is a cast of generally cuboid shape disposed adjacent to a wall of said waveguide.

Conveniently, the filter means can be a solid cuboid block or a hollow cuboid block. Alternatively, the filter means can be of any other suitable shape such as a rounded protrusion such as a quadrant.

Conveniently, the block is cast in the same material as the waveguide.

Preferably, the cast block is dimensioned and proportioned to reject the unwanted 13.75 GHz to 14.5 GHz transmit frequency band or some part of it.

According to another aspect of the invention there is provided an LNB comprising a waveguide with a filter cast in a wall of said waveguide, said LNG having at least one probe in said waveguide disposed next to said filter means, said probe passing through said waveguide wall and a microstrip circuit coupled to said probe.

Preferably, said VSAT system includes a waveguide horn.

Conveniently the cast filer has a flat front face, spaced from, and a similar distance along the waveguide as said at least one probe.

Preferably said LNB is for use with a VSAT system and said filter means is dimensioned and proportioned to reject the unwanted 13.75 GHz to 14.5 GHz frequency band.

In accordance with another aspect of the present invention, there is provided a method of manufacturing a waveguide for use with a VSAT system to minimize interference from an unwanted frequencies of transmit signals, said method comprising:

determining the dimensions and proportion of a waveguide filter, and

casting the waveguide and the determined waveguide filter simultaneously.

### BRIEF DESCRIPTION OF THE DRAWINGS

These and other aspects of the present invention will become apparent from the following description when taken in combination with the accompanying drawings in which:

FIG. 1 illustrates the electronics of a known VSAT system;

FIG. 2 is a 3-D end view of a waveguide with a waveguide filter in accordance with a first embodiment of the invention;

FIG. 3 is an enlarged end view of the actual waveguide showing the end face of the waveguide filter separated from the probe;

FIG. 4 is an enlarged, and partly cut away, view of the waveguide of FIG. 2 with the probe removed, depicted the waveguide wall cast with the filter;

FIG. 5 is a diagrammatic longitudinal sectional view through the waveguide of FIG. 2 showing the relative positioning of the front face of the waveguide and the probe;

FIG. 6 is a graph of insertion loss/response against frequency for the transmit and receive bands; and

FIG. 7 is an end view of a waveguide having a cast filter in accordance with a second embodiment of the invention.

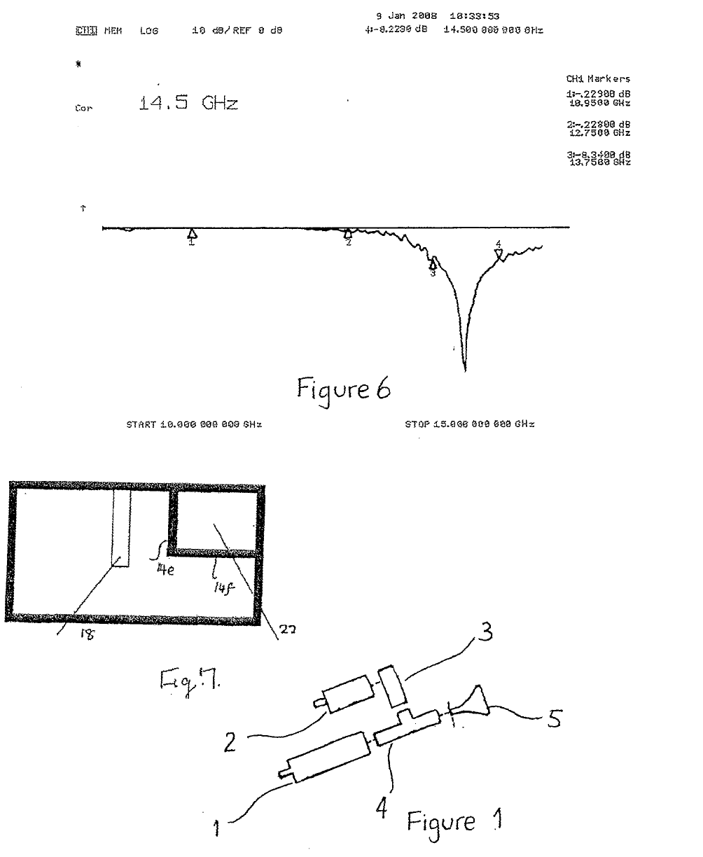

### DETAILED DESCRIPTION OF THE INVENTION

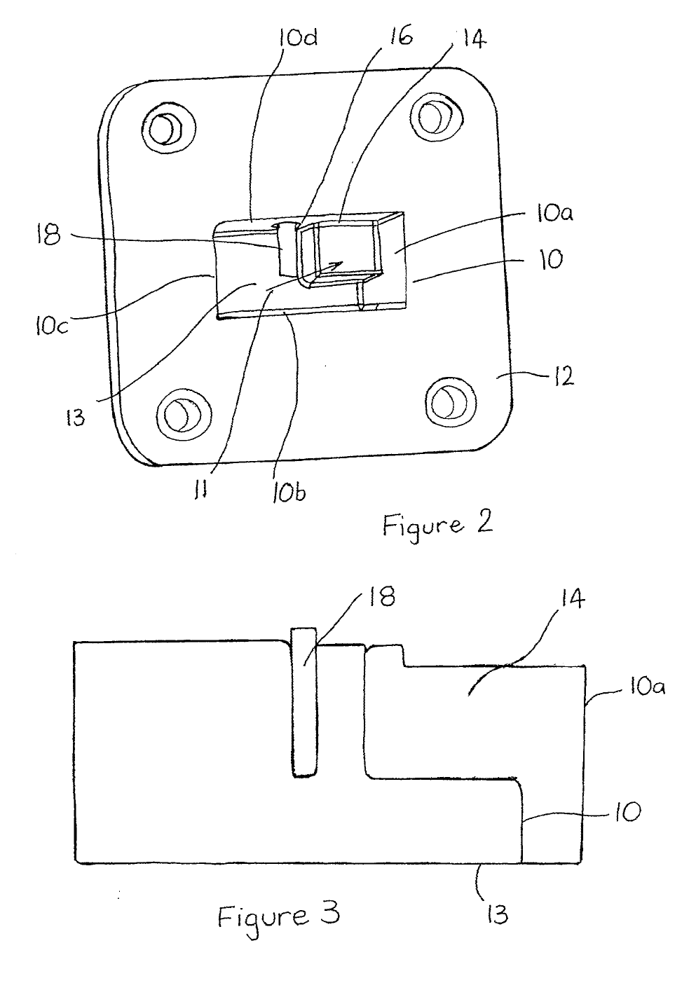

Reference is first made to FIG. 2 of the drawings which depicts an LNB cast metal aluminium rectangular waveguide generally indicated by reference numeral 10 having a longitudinal waveguide axis 11 and a front face 12 to which the rest of the VSAT electronics, not shown in the interests of clarity, can be coupled. The waveguide 10,12 is cast in a single manufacturing step with the rectangular waveguide 10 having four waveguide walls 10a, b, c and d, defining a waveguide interior 13. Waveguide wall 10a is cast with a cuboid-shaped waveguide filter 14 which extends partway across the waveguide interior 13. An aperture 16 is cast in waveguide surface 10d into which is inserted a probe 18 for receiving electromagnetic signals travelling in the waveguide 10.

As is best seen in FIG. 3, the probe 18 is spaced from the filter 14 which is dimensioned and proportioned to reject unwanted frequencies in the band 13.75 GHz to 14.5 GHz.

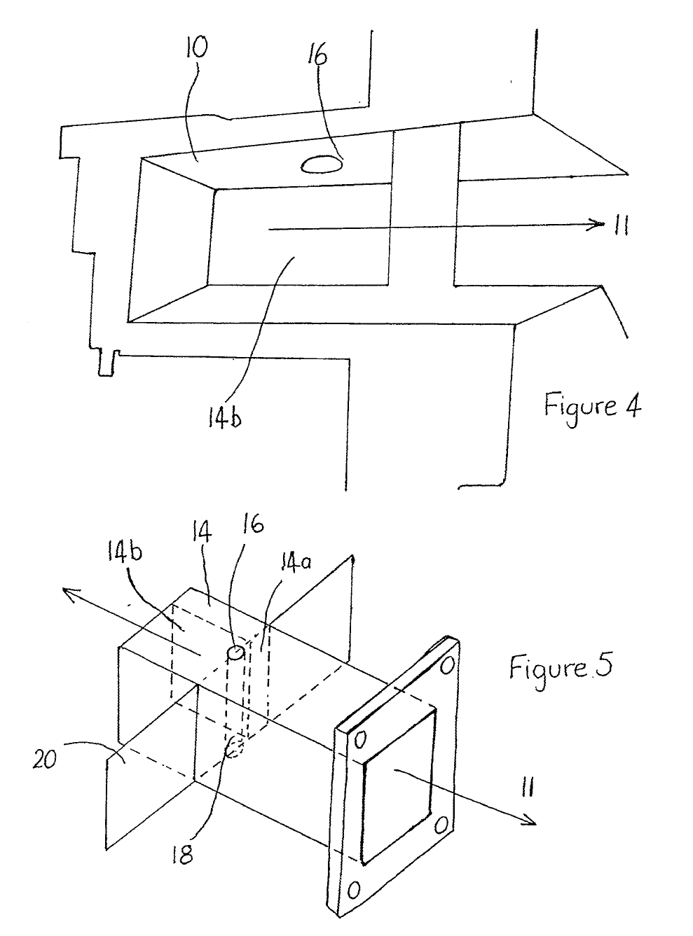

FIG. 4 is a longitudinal sectional view through the waveguide 10 and showing two faces; a front face 14a substantially orthogonal to the longitudinal axis 11 and a side face 14b which is parallel to the waveguide axis 11. The front face 14a and the probe aperture 16 are at substantially the same distance along the waveguide axis 11 so that when the probe 18 is inserted, as best seen in FIG. 5, the probe 18 and the front face 14a are also at a similar distance along the waveguide axis 11, on plane 20. This arrangement results in the filter in combination with the waveguide and probe rejecting the desired frequency range of signals from the transmit band.

FIG. 6 shows the insertion loss response against frequency and it will be seen that the ‘notch’ frequency response minimizes the signal in the unwanted frequency range 13.75 GHz-14.5 GHz of at least 8 dB at the band edges increasing to 38 dB in the middle of the range. This rejection minimizes interference with the receive signals and it will be seen from FIG. 6 that there is negligible effect on the receive frequency band of signals 10.7-12.75 GHz so that there is little loss incurred at the input of the LNB at the probe 18.

Various modifications may be made to the embodiment hereinbefore described without departing from the scope of the invention. For example, the filter can be dimensioned and proportioned so as to be cast in a different size to reject a desired range of frequencies. The waveguide and filter may be cast in zinc or any other castable metal or in a polymer and then coated in a metal or conductive layer to provide an operational waveguide. The waveguide and filter may be embodied in a circular or square waveguide with the filter also designed to reject a desired transmit frequency range. Besides being cuboid, the waveguide filter 14 could also take the form of a rounded protrusion such as a quadrant with modification to the length or may be replaced, as shown in FIG. 7, by two orthogonal walls parallel to the longitudinal axis 11 defining the outer faces 14e, 14f of a hollow cuboid with the front face removed so that faces 14e, 14f define an L-shape filter shown in end view. The end of the waveguide and filter is a short-circuit 22. Also, the probe 18 and face 14a and ends of faces 14e, 14f of the hollow cuboid do not need to be at exactly the same distance along the waveguide axis 11. They can be offset so long as the arrangement provides the desired rejection of the unwanted transmit frequencies.

The embodiment of the present invention provides advantages in that the cast filter which is integral with the waveguide provides a consistent filter performance across the desired range of frequencies, and it permits the waveguide and hence the LNB to be manufactured with fewer assembly steps thus minimizing cost.

1. A waveguide for use with a VSAT LNB comprising a waveguide housing having a waveguide wall for receiving electromagnetic radiation, the waveguide housing having a probe aperture receiving at least one probe for coupling the electromagnetic signal in the waveguide to an electrical signal in a circuit board, filter means cast into said waveguide wall for rejecting selected frequencies in a transmit band.

2. A waveguide as claimed in claim 1, wherein the filter means is cast in said waveguide wall adjacent to said probe aperture.

3. A waveguide as claimed in claim 2, wherein the filter means is dimensioned and proportioned to provide cancellation of a selected range of frequencies.

4. A waveguide as claimed in claim 1, wherein the filter means is a cast of generally cuboid shape disposed adjacent to a wall of said waveguide.

5. A waveguide as claimed in claim 1, wherein the filter means is a solid cuboid block or a hollow cuboid block.

6. A waveguide as claimed in claim 1, wherein the filter means is of any other suitable shape such as a rounded protrusion such as a quadrant.

7. A waveguide as claimed in claim 1, wherein the block is cast in the same material as the waveguide.

8. A waveguide as claimed in claim 1, wherein the cast block is dimensioned and proportioned to reject the unwanted 13.75 GHz to 14.5 GHz transmit frequency band or some part of it.

9. An LNB comprising a waveguide with a filter cast in a wall of said waveguide, said LNB having at least one probe in said waveguide disposed next to said filter means, said probe passing through said waveguide wall and a microstrip circuit coupled to said probe.

10. An LNB as claimed in claim 9, wherein the waveguide is used with a VSAT system which includes a horn.

11. An LNB as claimed in claim 9, wherein the cast filter has a flat front face, spaced from, and a similar distance along the waveguide as said at least one probe.

12. An LNB as claimed in claim 9, wherein said LNB is for use with a VSAT system and said filter means is dimensioned and proportioned to reject the unwanted 13.75 GHz to 14.5 GHz frequency band.

13. A method of manufacturing a waveguide for use with a VSAT system to minimise interference from an unwanted frequencies of transmit signals, said method comprising: determining the dimensions and proportion of a waveguide filter, and casting the waveguide and the determined waveguide filter simultaneously.
